(19) United States
(12) Patent Application Publication
(10) Pub. No.: US 2015/0189158 A1
(43) Pub. Date: Jul. 2, 2015

(54) SYSTEMS, METHODS, AND MEDIA FOR PRESENTING A FIELD OF VIEW FROM A CAMERA OF A DEVICE ON A DISPLAY OF THE DEVICE IN THE BACKGROUND OF NON-CAMERA FUNCTIONALITY

(71) Applicant: Connor Hailey, New York, NY (US)

(72) Inventor: Connor Hailey, New York, NY (US)

(21) Appl. No.: 14/585,090

(22) Filed: Dec. 29, 2014

Related U.S. Application Data
(60) Provisional application No. 61/921,413, filed on Dec. 28, 2013.
(60) Provisional application No. 61/978,742, filed on Apr. 11, 2014.

(51) Int. Cl. H04N 5/232; H04N 5/225

(52) U.S. Cl. CPC H04N 5/23212; H04N 5/2252

(57) ABSTRACT

Systems, methods, and media for presenting a field of view from a camera of a device on a display of the device in the background of non-camera functionality are provided. In some embodiments, systems for presenting a field of view from a camera of a device on a display of the device in the background of non-camera functionality are provided, the systems comprising: a case incorporating a mirror pivotably mounted to the case in a manner that the field of view can be reflected into a camera lens of the device when mounted in the case; and a hardware processor configured to receive an image of the field of view as reflected by the mirror; generate a new image based on the image; present the new image as a background image on the display; and provide non-camera functionality on the display while presenting the background image.

### CROSS REFERENCE TO RELATED APPLICATIONS

This application claims the benefit of U.S. Provisional Patent Applications Nos. 61/921,413, filed Dec. 28, 2013, and 61/978,742, filed Apr. 11, 2014, each of which is hereby incorporated by reference herein in its entirety.

### BACKGROUND

With the continuous increase in usage of mobile computing devices, such as mobile phones, mobile communication device (such as email devices), tablet computers, portable gaming consoles, personal data assistants, etc., in recent years, a common behavior of users of such devices has been a user walking with his or her eyes focused on such a device while unintentionally walking into an obstruction, into other people, off a curb, into traffic, etc. Obviously, this creates a safety risk to such users that is undesirable.

Part of the cause for this behavior is that a typical user is frequently walking with his or her eyes looking downward at a device (which is held almost horizontally in front of the user) rather than looking in the direction that he or she is walking

Accordingly, it is desirable to provide mechanisms which allow users to safely focus on the users' devices while walking

### SUMMARY

Systems, methods, and media for presenting a field of view from a camera of a device on a display of the device in the background of non-camera functionality are provided. In some embodiments, systems for presenting a field of view from a camera of a device on a display of the device in the background of non-camera functionality are provided, the systems comprising: a case incorporating a mirror pivotably mounted to the case in a manner that the field of view can be reflected into a camera lens of the device when mounted in the case; and a hardware processor configured to receive an image of the field of view as reflected by the mirror; generate a new image based on the image; present the new image as a background image on the display; and provide non-camera functionality on the display while presenting the background image.

In some embodiments, methods for presenting a field of view from a camera of a device on a display of the device in the background of non-camera functionality are provided, the methods comprising: receiving an image of the field of view as reflected by the mirror; generating a new image based on the image; presenting the new image as a background image on the display; and providing non-camera functionality on the display while presenting the background image.

In some embodiments, non-transitory computer-readable media containing computer-executable instructions that, when executed by a processor, cause the processor to perform a method for presenting a field of view from a camera of a device on a display of the device in the background of non-camera functionality are provided, the method comprising: receiving an image of the field of view as reflected by the mirror; generating a new image based on the image; presenting the new image as a background image on the display; and providing non-camera functionality on the display while presenting the background image.

### BRIEF DESCRIPTION OF THE DRAWINGS

FIGS. 1A, 1B, and 1C are illustrations of the basic use of a case and software for a mobile device in accordance with some embodiments.

FIGS. 2A and 2B are perspective views of an example of a case with a mirror in a deployed position in accordance with some embodiments.

FIGS. 3B and 3B are perspective views of an example of a case with a mirror in a stowed position accordance with some embodiments.

FIG. 4 is an example of a user interface of a mobile device in accordance with some embodiments.

FIG. 5 is another example of a user interface of a mobile device in accordance with some embodiments.

FIG. 6 is yet another example of a user interface of a mobile device in accordance with some embodiments.

FIG. 7 is an example of a flow diagram of a process that can be executed by a hardware processor of a mobile device in accordance with some embodiments.

FIG. 8 is an example of hardware that can be used in a mobile device in accordance with some embodiments.

### DETAILED DESCRIPTION

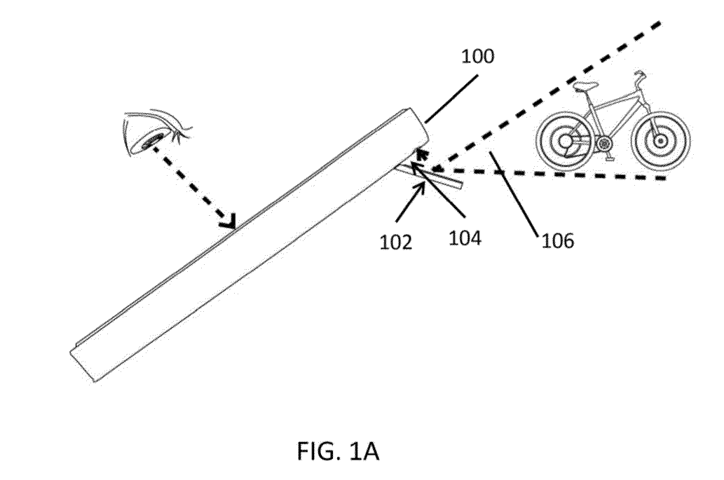

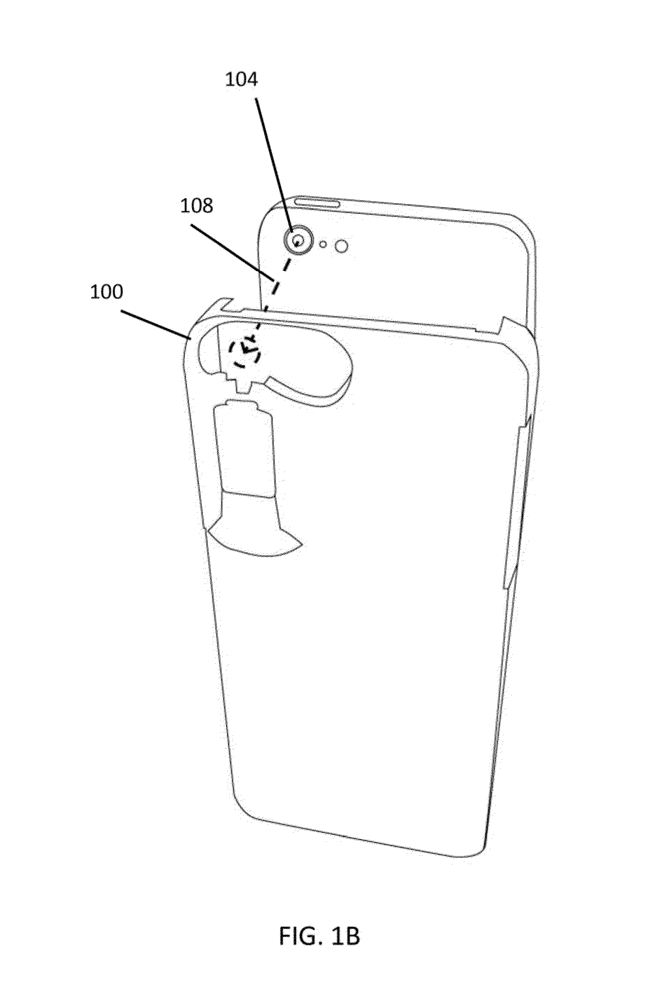

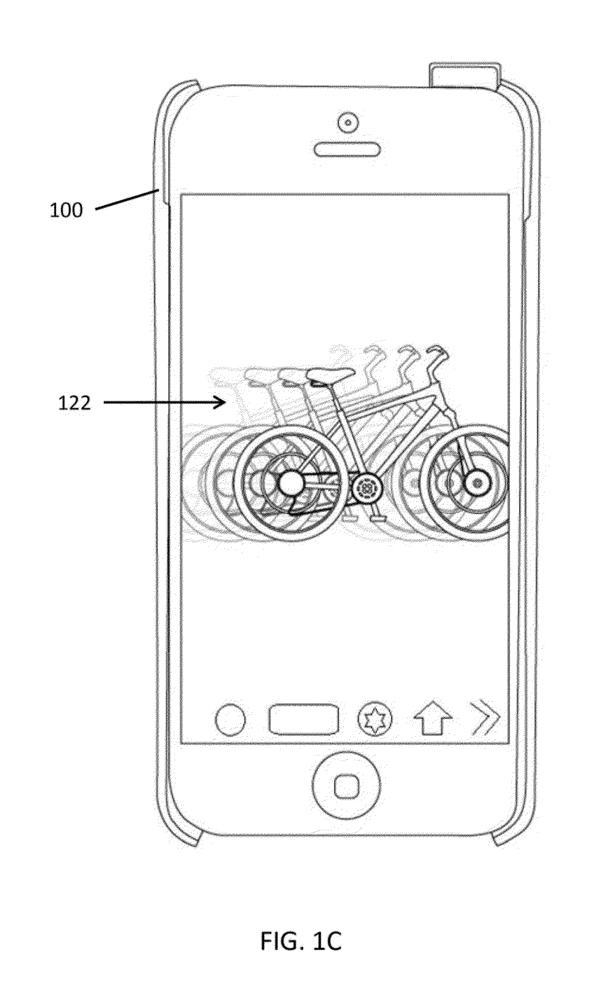

In accordance with some embodiments, a case with a hinged mirror for a mobile device is provided. An example 100 of a case in accordance with some embodiments is shown in FIGS. 1A, 1B, 1C, 2A, 2B, 3A, and 3B. As illustrated in FIGS. 1A and 1B, a hinged mirror 102 on case 100 can be deployed and adjusted by a user in order to reflect light 106 into a camera lens 104 from in front of the case while the case is oriented in a direction 108 that would otherwise cause the camera lens to be pointed away from a desired field of view. In some embodiments, software that can be executed by a processor of a mobile device is provided. When executed by the hardware processor, the software can process and display the field of view reflected into the camera lens by the mirror on a display 122 of the mobile device (as shown in FIG. 1C), and enable the user to carry out common non-camera functionality (e.g., common smart phone tasks) while displays related to those tasks are superimposed onto the displayed field of view, in accordance with some embodiments.

Although some embodiments are described as having a case for a mobile device, the case can be a part of the body of the mobile device and need not be a separate case. For example, the case can be the back cover of the mobile phone in some embodiments.

Any suitable mirror can be used in some embodiments. For example, in some embodiments, the mirror can have any suitable shape. More particularly, for example, the mirror can be round, square, rectangular, concave, convex, etc. As another example, in some embodiments, the mirror can have any suitable dimensions. As yet another example, in some embodiments, the mirror can be made from any suitable material, such as glass, plastic, or metal.

In some embodiments, the mirror can be replaced with any other suitable mechanism for changing the direction of light, such as a prism.

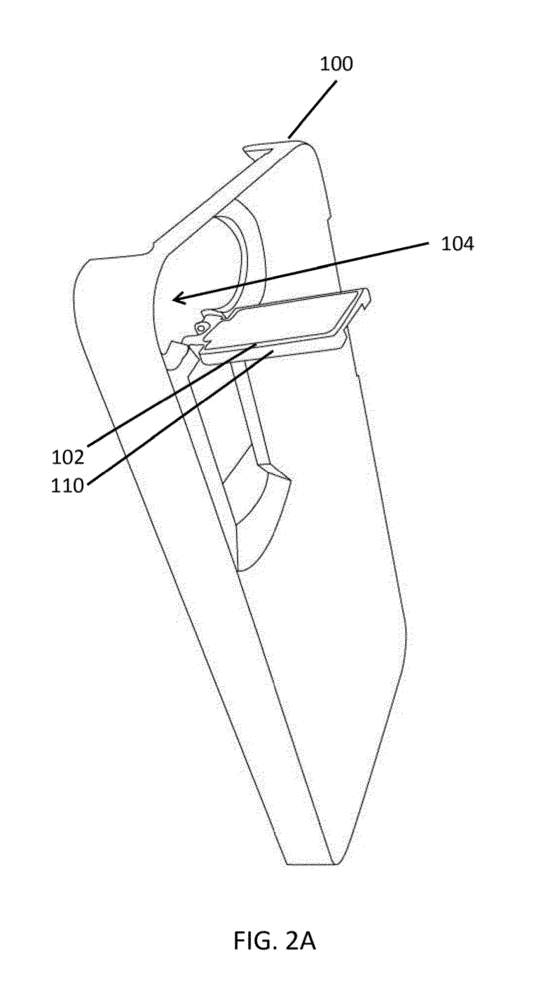

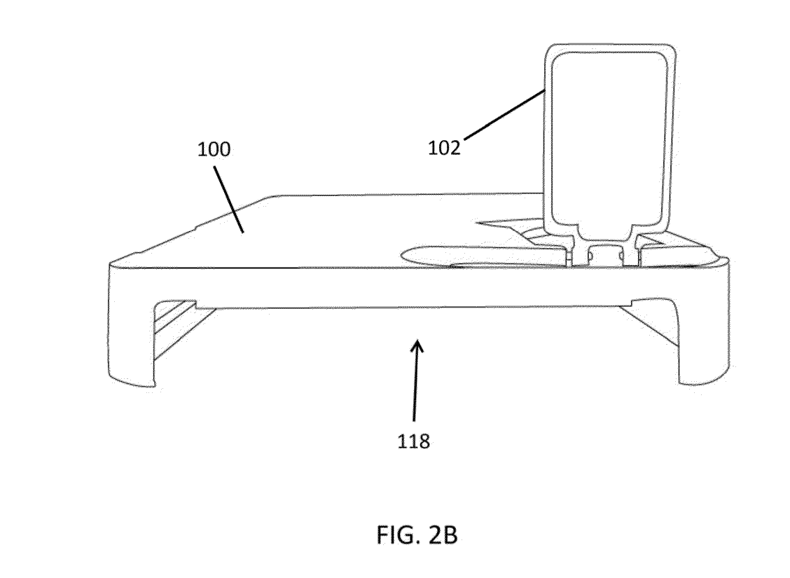

The hinged mirror can be attached to the case in any suitable manner. For example, in accordance with some embodiments, as shown in FIGS. 2A and 2B, the case can contain a hinged paddle 110 positioned directly below lens 104 of the mobile device, and mirror 102 can be attached to the paddle in any suitable manner (e.g., using an adhesive).

The hinged paddle can be attached to the case in any suitable manner that allows the case to move in a desired range of motion. For example, in some embodiments, the hinged paddle can be attached to the case using a ball and socket hinge.

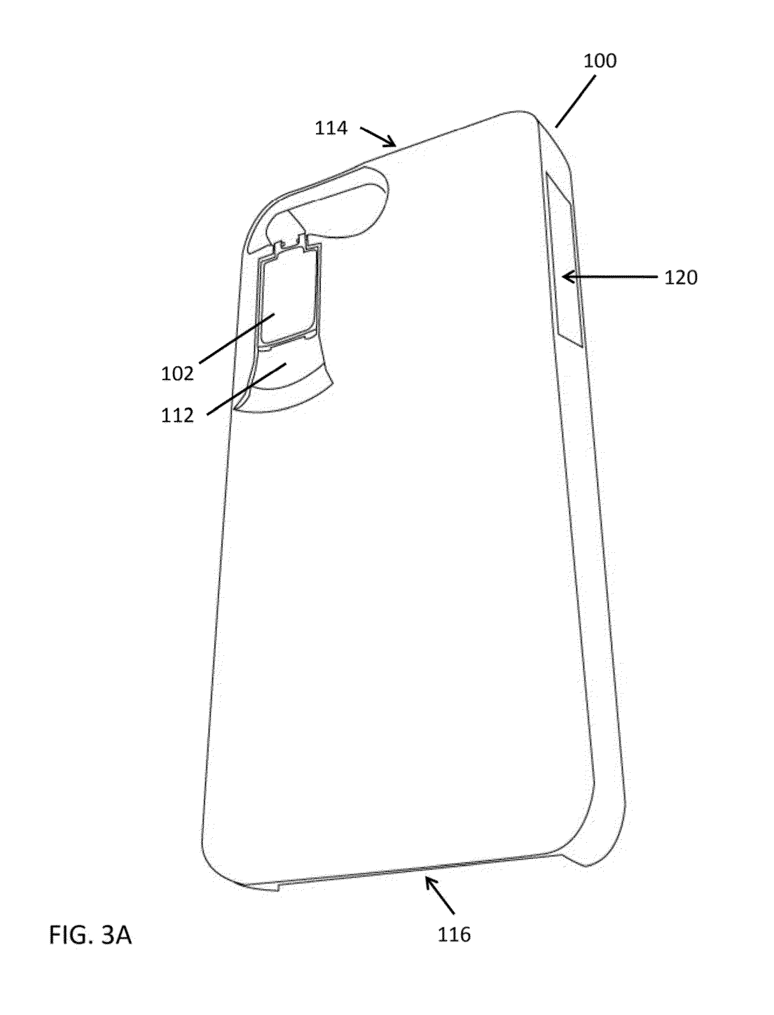

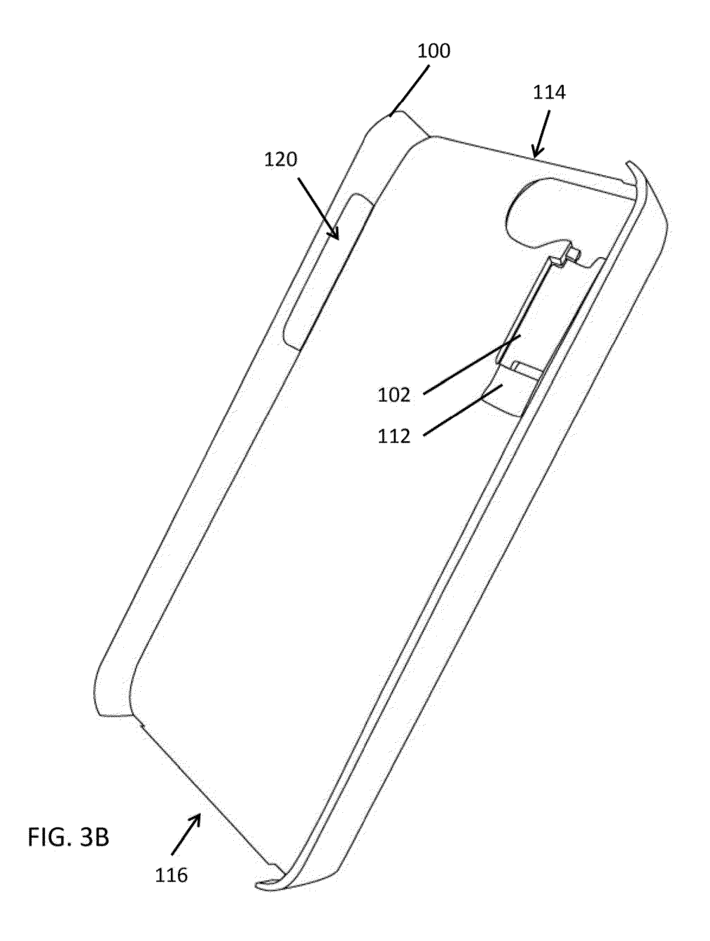

Hinged paddle 110 can have any suitable range of motion (e.g., such as 170 degrees). In some embodiments, in one position, as shown in FIGS. 3A and 3B, the hinged paddle is level with the back of the case, so that it does not significantly protrude from the back of the case while it is not being used. In some embodiments, just below the hinged paddle, there is a bevel 112 that allows the user to lift the hinged paddle into position with a finger.

In accordance with some embodiments, the body of the case (excluding the hinged paddle) is a single-body case. In some embodiments, it can be molded out of any suitable material (e.g., such as hard polycarbonate) in a configuration in which a top end 114 and a bottom end 116 (both shown in FIGS. 3A and 3B) are not completely closed (as shown by region 118 of FIG. 2B) to allow the case to bend when the user puts a device (e.g., such as a smart phone) in the case. In some embodiments, case 100 contains an opening 120 (as shown in FIGS. 3A and 3B) on the left side to allow the user access to the volume and hold buttons.

In some embodiments, in order to view images from the camera while performing other functions, software can by executed by a hardware processor of the mobile device.

In some embodiments, the software can process the image captured by the camera and generate a new image showing the camera field of view. For example, the field of view can first be reflected by the mirror, and then the camera can capture the reflected image. In such an example, the software can invert the image captured by the camera and generate a new image of the camera field of view in a normal viewing angle. As another example, when the mirror is not a flat mirror, but a convex mirror instead, the image captured by the camera can include wider field of view and can be deformed by the convex mirror. In such an example, the software can process the image to generate a wide-angle distortion corrected image as the camera field of view. In yet another example, the software can change any suitable parameter of the image captured by the camera, such as white balance, sharpness, contrast, color saturation, etc., and generate a definition-enhanced image as the camera field of view.

In some embodiments, the software can detect and/or recognize objects in the processed image using any suitable object detection and/or recognition technique, such as template matching, image segmentation, edge matching, greyscale matching, gradient matching, color matching, feature matching, etc. In response to detecting a predetermined object (e.g., a moving car, a crawling baby, pedestrian crosswalk, etc.), the software can make a warning signal, such as a vibration of the device, a noise, a flashing light, a notification on the screen, an/or any other suitable warning signal.

In some embodiments, actions performed using the software or another application that is run while executing the software can be superimposed onto the camera field of view. The software can include any suitable functionalities, such as: implementing a short messaging service client; implementing an e-mail client; performing TWITTER and FACEBOOK updates; providing an Internet browser; and providing camera functionality. In some embodiments, each of these functionalities can be contained in a different view that the user can manipulate. In some embodiments, each view can contain a menu that can be swiped in and out from the left side of the screen giving users access to the functionalities and a settings view.

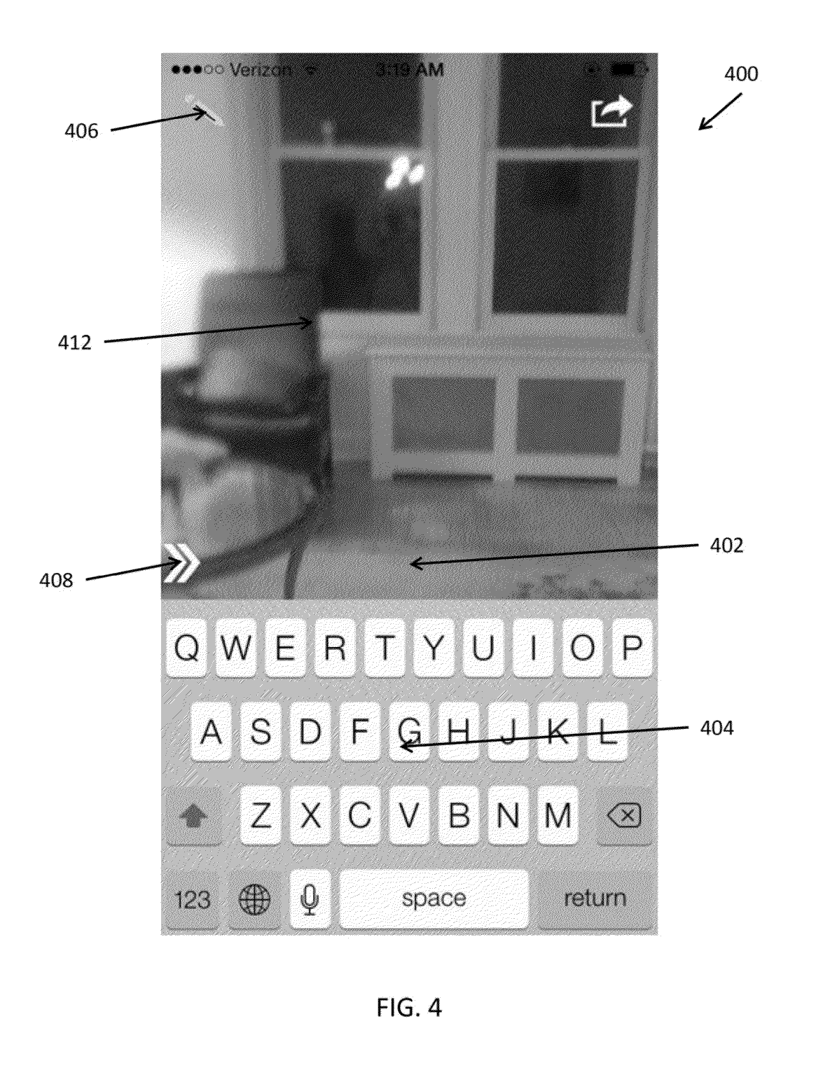

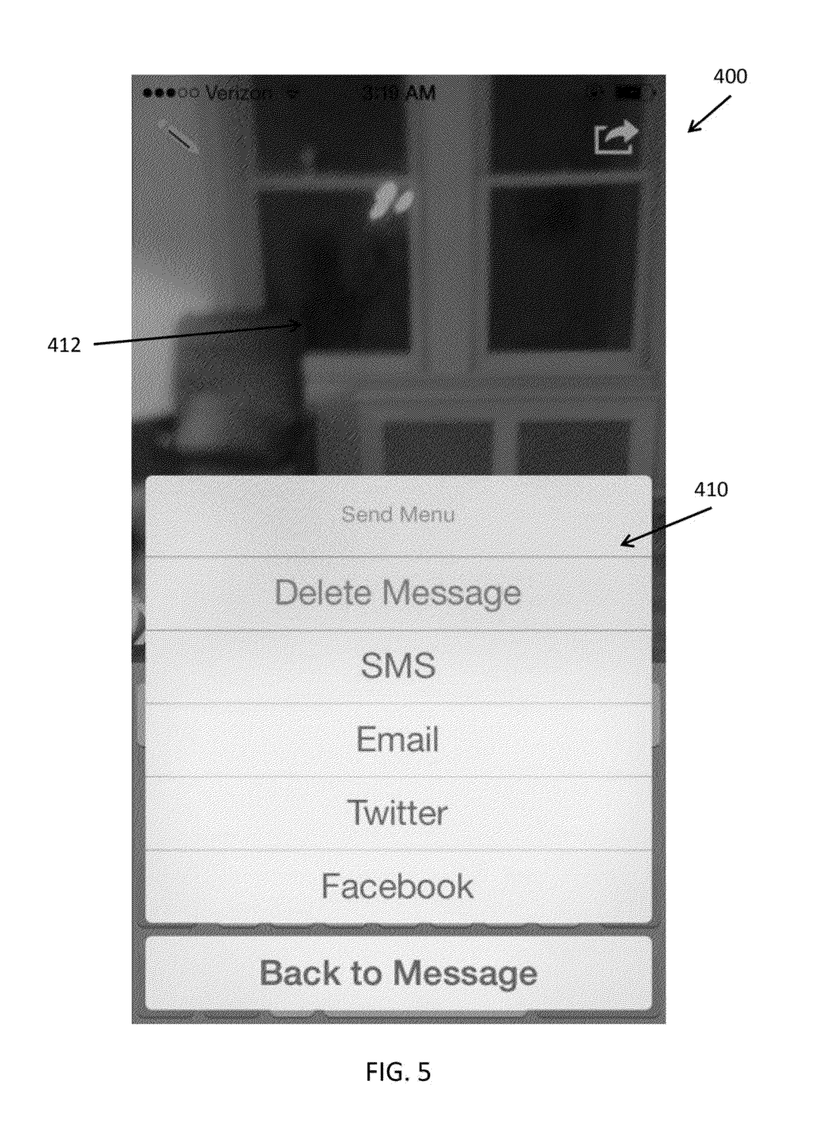

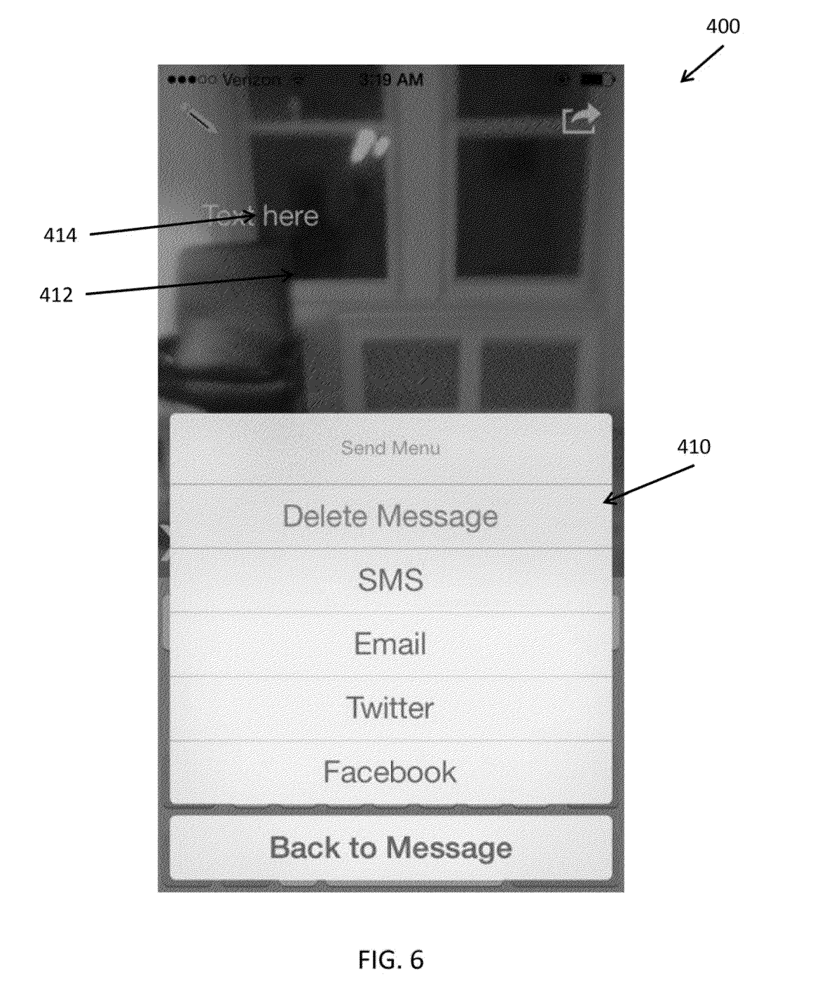

As shown in FIG. 4-6, in accordance with some embodiments, an example 400 of a view for one functionality can contain a text field 402 or 414 (e.g., to be used with a short messaging service (SMS)) in which the user can type a message (e.g., using virtual keyboard 404). It can contain a button or icon 406 that can allow a user to change the color (or any other suitable parameter) of the text in the text field. It can contain a button or icon 408 that displays a menu 410 allowing the user to choose whether he or she would like to send the message in the text field through SMS, e-mail, or upload to TWITTER or FACEBOOK, or any other suitable mechanism. If the user chooses SMS or e-mail, it can take him/her to a screen that allows him/her to choose a recipient and/or any other suitable characteristics. If the user chooses to TWITTER or FACEBOOK, a TWITTER/FACEBOOK display can be shown and the user can be given the option to upload a message and/or perform any other suitable action. The software can copy the text from the text field and insert it into interfaces provided by third party applications in some embodiments. For example: if the user chooses to send an SMS or an e-mail, the software can copy the text from the text field into send modules for SMS and e-mail (e.g., those provided by APPLE INC.). If the user chooses to upload to TWITTER or FACEBOOK, then the text can be copied into those social networks' upload modules.

In accordance with some embodiments, the view for another functionality can contain a web view (in which a web page can be displayed), forward and back buttons, three (or any suitable number) “favorites” icons, a text field in which the user can type a URL address or search any suitable search engine (e.g., GOOGLE), and/or any other suitable features. The forward and back buttons can allow users to go back to the previous web page, or forward to the one from which the user just came in some embodiments. The “favorites” icons (which can be user-defined in the settings view) can take a user to his/her predetermined, most-used web sites in some embodiments.

In accordance with some embodiments, the view for still another functionality can contain buttons that allow the user to take a picture, retake a picture, rotate the camera view by 180 degrees, and/or perform any other suitable action, and upload pictures to FACEBOOK, TWITTER, INSTAGRAM, or any other suitable service, save them to the camera roll, or perform any other suitable action. In some embodiments, this view can contain an image view that shows the image the user has just taken, allowing the user to review the image and decide what will be done with the picture.

In some embodiments, a settings view can contain four text fields, a sliding bar and a “Save Changes” button, and/or any other suitable features. One text field can allow the user to set his or her home page and the other three text fields can be for the user's favorite pages, in some embodiments. The sliding bar can allow the user to set the transparency of the web view on a scale of 1-5 (or any other suitable range), from completely opaque to completely transparent, in some embodiments. The “Save Changes” button can allow the user to save the changes he or she has made in the text fields and the sliding bar, and/or any other suitable parameters. The user can then be returned to the view of the first functionality.

In some embodiments, the view for yet another functionality can include an RSS reader that is superimposed on the camera view background. It can contain a table of articles that the user has expressed interest in reading (through his or her marked RSS articles or predefined options that can be presented to the user), in some embodiments. Each table view cell can have the title of an article, a short description and a timestamp in some embodiments. Clicking on an article can take the user to a detail view that contains a web view that will be loaded with the RSS article in some embodiments.

In some embodiments, the view for yet another functionality can include a dedicated e-mail client (such as an e-mail client provided by APPLE INC.) that can be superimposed on a camera view. It can include any suitable functionalities of an e-mail client including: sending and receiving e-mails, drafts, trash cans, IMAP/POP access, etc.

In some embodiments, the view for yet another functionality can include a dedicated messaging client such as IMESSAGE from APPLE INC. or WHATSAPP. The messaging service can act as others do except for the fact that it can be superimposed on a camera background in some embodiments.

In some embodiments, the view for yet another functionality can include a map view (e.g., GOOGLE map application, BING map application, etc.) that can be superimposed on a camera view. For example, in some embodiments, a map application can locate the current location of the device through any suitable signal, such as Global Positioning System (GPS) signal, WiFi signal, 4G signal, etc. The software can superimpose a map of the current location over the camera view in some embodiments. In such an example, the map view functionality can allow a user to look at directions, find a route and be more aware of the user's surroundings.

Referring back to FIGS. 4-6, as illustrated in these figures, a processed image of a field of view reflected into a camera lens by a mirror can be presented as a background image 412. In the example shown, this field of view shows a room with two windows, a radiator, a chair, and a table. As shown in FIG. 4, a user can type text in an area 414 that shows the background image in some embodiments. In this way, a user of some embodiments of the mechanisms described herein can type and see objects in the field of view.

In some embodiments, alternatively to being presented as a background image, a processed image of a field of view reflected into a camera lens by a mirror can be presented in a small window that occupies a portion of the screen. One or more functionalities described above can be displayed in another portion of the screen, such as the rest of the screen.

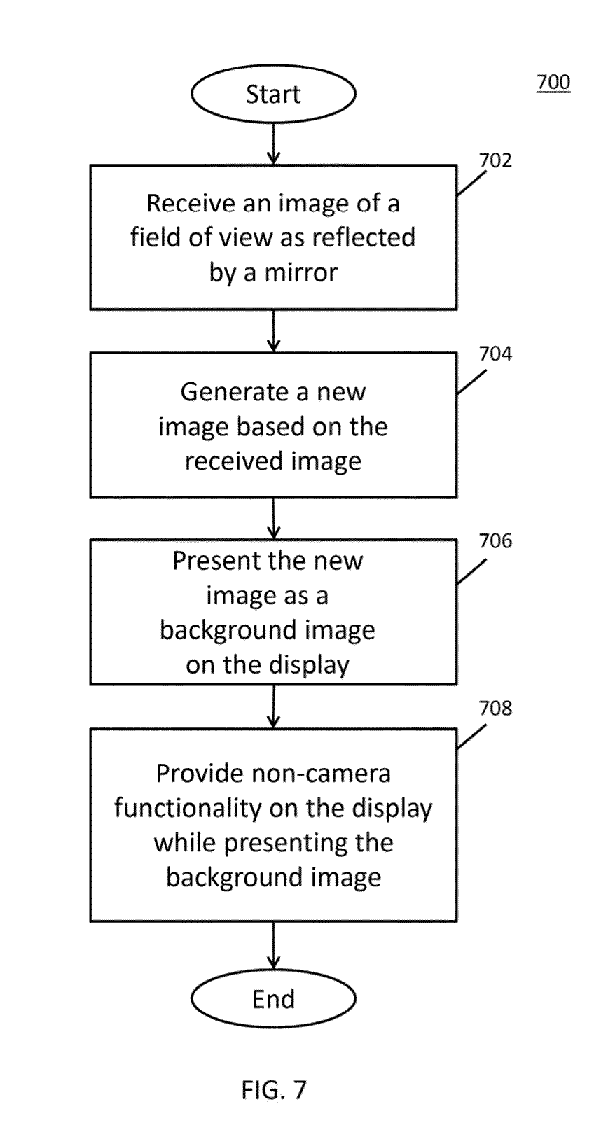

Turing to FIG. 7, an example 700 of a process that can be executed by a hardware processor of a mobile device in accordance with some embodiments is shown. As illustrated, after process 700 begins, at 702 the process can receive an image of a field of view as reflected by a mirror. Any suitable image can be received from any suitable source, and in any suitable manner. For example, in some embodiments, the image can be received from memory in which a separate process previously stored the image. As another example, in some embodiments, the image can be received directly from a camera sensor in response to an instruction from process 700.

Next, at 704, process 700 can generate a new image based on the image received at 702. This image can be generated in any suitable manner and for any suitable purpose. For example, in some embodiments, the new image can be generated by performing a transform on the image to correct the image for inversion and/or distortion. As another example, in some embodiments, the new image can be generated using standard image processing techniques to correct the color in the received image, change the contrast of the received image, sharpen the received image, remove noise in the received image, etc.

Then, at 706, process 700 can present the new image as a background image on a display of the mobile device, or a display couple to the mobile device (such as a display that is part of glass, a virtual reality headset, etc.). This new image can be presented in any suitable manner.

Process 700 can next provide non-camera functionality in the foreground on the display while presenting the background image, at 708. Any suitable functionality (such as those described above) can be provided in any suitable manner.

It should be understood that at least some of the above described steps of the processes of FIG. 7 can be executed or performed in any order or sequence not limited to the order and sequence shown and described in the figure. Also, some of the above steps of the processes of FIG. 7 can be executed or performed substantially simultaneously where appropriate or in parallel to reduce latency and processing times.

Any suitable methodology can be used to implement the software in some embodiments. For example, in some embodiments, the software can utilize the Model-View-Controller methodology. Also, any suitable programming language(s) can be used to implement the software in some embodiments.

As described above, the software and any applications operating in conjunction with the software can be executed (or run) by a hardware processor of a mobile device (such as a smart phone). In some embodiments, this software and the case described herein can be executed (or run) on and used with, respectively, any suitable mobile device, such as a smart phone, a tablet computer, a personal data assistant, a camera, a mobile gaming device, or any other suitable mobile device that includes a camera and a display and that can provide non-camera functionality.

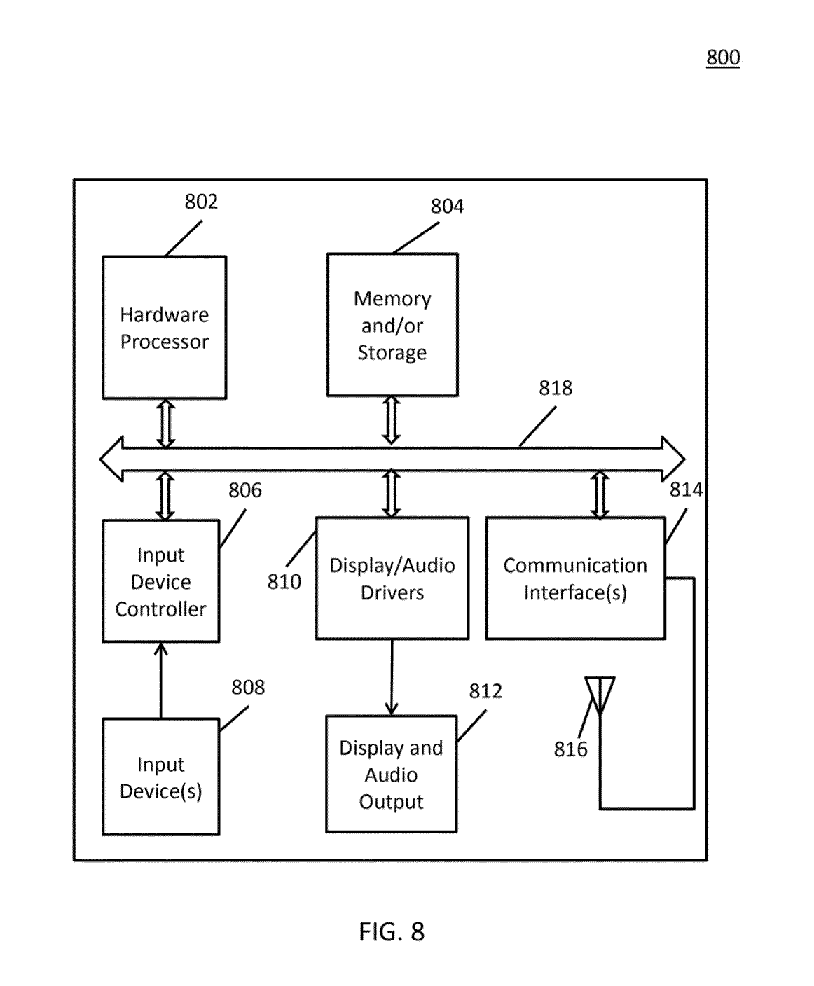

Any of the mobile devices can be implemented using any suitable hardware in some embodiments. For example, in some embodiments, these devices can be implemented using any suitable general purpose computer or special purpose computer. Any such general purpose computer or special purpose computer can include any suitable hardware. For example, as illustrated in example hardware 800 of FIG. 8, such hardware can include a hardware processor 802, memory and/or storage 804, an input device controller 806, an input device 808, display/audio drivers 810, display and audio output circuitry 812, communication interface(s) 814, an antenna 816, and a bus 818.

Hardware processor 802 can include any suitable hardware processor, such as a microprocessor, a micro-controller, digital signal processor, dedicated logic, and/or any other suitable circuitry for controlling the functioning of a general purpose computer or special purpose computer in some embodiments.

Memory and/or storage 804 can be any suitable memory and/or storage for storing programs, data, images, video, e-mail messages, text messages, web page content, etc. in some embodiments. For example, memory and/or storage 804 can include random access memory, read only memory, flash memory, hard disk storage, optical media, etc.

Input device controller 806 can be any suitable circuitry for controlling and receiving input from one or more input devices 808 in some embodiments. For example, input device controller 806 can be circuitry for receiving input from a touch screen, from one or more buttons, from a voice recognition circuit, from a microphone, from a camera, from an optical sensor, from an accelerometer, from a temperature sensor, from a near field sensor, etc.

Display/audio drivers 810 can be any suitable circuitry for controlling and driving output to one or more display and audio output circuitries 812 in some embodiments. For example, display/audio drivers 810 can be circuitry for driving an LCD display, a speaker, an LED, etc.

Communication interface(s) 814 can be any suitable circuitry for interfacing with one or more communication networks, such as the wireless communication network (e.g., a mobile data network) in some embodiments. For example, interface(s) 814 can include network interface card circuitry, wireless communication circuitry, etc.

Antenna 816 can be any suitable one or more antennas for wirelessly communicating with a communication network in some embodiments. In some embodiments, antenna 816 can be omitted when not needed.

Bus 818 can be any suitable mechanism for communicating between two or more of components 802, 804, 806, 810, and 814 in some embodiments.

Any other suitable components can be included in hardware 800 in accordance with some embodiments.

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A system for presenting a field of view from a camera of a device on a display of the device in the background of non-camera functionality, comprising:
a case incorporating a mirror pivotably mounted to the case in a manner that the field of view can be reflected into a camera lens of the device when mounted in the case; and
a hardware processor configured to:
receive an image of the field of view as reflected by the mirror;
generate a new image based on the image;
present the new image as a background image on the display; and
provide non-camera functionality on the display while presenting the background image.

2. The system of claim 1, wherein the mirror is mounted on a paddle that is coupled to the case using a ball-socket hinge.

3. The system of claim 1, wherein the mirror is configured to stow substantially flat on the back of the case.

4. The system of claim 1, wherein the non-camera functionality is an Internet browser.

5. The system of claim 1, wherein the non-camera functionality is an SMS client.

6. The system of claim 1, wherein the non-camera functionality is a social media client.

7. The system of claim 1, wherein the hardware processor is also configured to generate an alert regarding an obstacle detected based on the received image.

8. The system of claim 1, wherein generating the new image based on the image includes inverting the image.

9. A method for presenting a field of view from a camera of a device on a display of the device in the background of non-camera functionality, comprising:
receiving an image of the field of view as reflected by the mirror;
generating a new image based on the image;
presenting the new image as a background image on the display; and
providing non-camera functionality on the display while presenting the background image.

10. The method of claim 9, wherein the non-camera functionality is an Internet browser.

11. The method of claim 9, wherein the non-camera functionality is an SMS client.

12. The method of claim 9, wherein the non-camera functionality is a social media client.

13. The method of claim 9, further comprising generating an alert regarding an obstacle detected based on the received image.

14. The method of claim 9, wherein generating the new image based on the image includes inverting the image.

15. A non-transitory computer-readable media containing computer-executable instructions that, when executed by a processor, cause the processor to perform a method for presenting a field of view from a camera of a device on a display of the device in the background of non-camera functionality, comprising:
receiving an image of the field of view as reflected by the mirror;
generating a new image based on the image;
presenting the new image as a background image on the display; and
providing non-camera functionality on the display while presenting the background image.

16. The non-transitory computer-readable media of claim 15, wherein the non-camera functionality is an Internet browser.

17. The non-transitory computer-readable media of claim 15, wherein the non-camera functionality is an SMS client.

18. The non-transitory computer-readable media of claim 15, wherein the non-camera functionality is a social media client.

19. The non-transitory computer-readable media of claim 15, wherein the method further comprises generating an alert regarding an obstacle detected based on the received image.

20. The non-transitory computer-readable media of claim 15, wherein generating the new image based on the image includes inverting the image.
